(19) United States
(12) Patent Application Publication
(10) Pub. No.: US 2015/0068720 A1
(43) Pub. Date: Mar. 12, 2015

(54) Method and Apparatus for an Infant-milk Warmer

(71) Applicant: REST DEVICES, INC., Boston, MA (US)

(72) Inventors: Thomas Lipoma, Boston, MA (US); Chao He, Boston, MA (US); Carson Darling, Boston, MA (US); Katy Gero, Cambridge, MA (US); Dulcie Madden, Boston, MA (US)

(21) Appl. No.: 14/479,957

(22) Filed: Sep. 8, 2014

Related U.S. Application Data
(60) Provisional application No. 61/875,310, filed on Sep. 9, 2013.
(60) Provisional application No. 61/890,405, filed on Oct. 14, 2013.

(51) Int. Cl. A23L 1/29; F28F 27/00

(52) U.S. Cl. CPC A23L 1/296; F28F 27/00
USPC 165/222; 165/201; 165/253

(57) ABSTRACT

A method and system for controlling the storage and preparation of a container of milk for feeding is disclosed. The system employs collected information associated with the infant or the caregiver to initiate controls of the temperature of the milk without the user's interaction.

### CROSS-REFERENCE TO RELATED APPLICATIONS

This application claims priority from U.S. provisional patent application Ser. No. 61/875,310 filed Sep. 9, 2013, entitled “Method and Apparatus for an Infant-milk Warmer,” and U.S. provisional patent application Ser. No. 61/890,405 filed Oct. 14, 2013.” Each of these applications is hereby incorporated herein by reference, in its entirety.

### TECHNICAL FIELD

The present invention relates infant-milk warmers, and more particularly, to controlling infant-milk warmers.

### BACKGROUND

Milk should be stored at a cold temperature to prevent spoilage and served at an elevated temperature, typically near body temperature, to an infant. For that reason, caregivers (for example, parents) may keep milk in a refrigerator and heat the milk immediately prior to feeding it to the infant. “Milk,” as used herein, refers to diary milk, breast milk, milk formula, infant formula, and other type of liquid nutrients that generally contains lactose.

Existing heating devices are known that can assist the caregivers in preparing milk quickly for feeding. However, use of these devices is typically initiated by the caregiver themselves, and often only upon their own personal realization of the infant's need to feed.

### SUMMARY

In accordance with a first embodiment of the invention, there is provided a system and method of heating or cooling a container of liquid. In this embodiment the method includes collecting information associated with use of the liquid container. The system determines if a user of the container is likely to heat or cool a container of liquid based, at least in part, on the information. The system then heats or cools the container of liquid, or enters the heating or cooling state, as a function of the determination. The method may be performed by a countertop system, a portable device, or a server.

The system is preferably a countertop or portable device configured as a cooler and a warmer. In an embodiment, the system includes a thermoelectric device for both cooling and heating of the liquid. Prior to initiating the control state, the system may maintain the liquid temperature at a specified storage temperature. Upon being initiated to a heating or cooling state, the system controls the temperature to a specified state temperature. The system may initiate either the heating or cooling state without the user interaction though may additionally accept user's preferences as well as determine the user preferences based on collected information.

The system may use collected information about the container of liquid, the infant, the user (such as the caregiver), or the environment associated with the infant. The collected information is used to determine when to initiate control states of the system. The control state may include the heating or the cooling of the container, which may be used to serve milk and/or infant formula.

In an embodiment, the system determines a likelihood value based on the collected information. Upon the likelihood value exceeding a threshold, the system may initiate various control states of the device. The control states include a state for heating and a state for cooling.

Information about the container may include liquid volume, expiration date, weight, and/or temperature. Information about the user may include the user's identity, the user's location, and the user's proximity from the device. The system may collect or derive usage statistics associated with the usage of the container for each infant. Such information may include time of use information and the user identity. Information about the infant may include the infant age, weight, time asleep, time awake, temperature, movement, mood, and/or sound levels. Environmental information may include room temperature, location, light levels, sound levels, time, humidity levels, and/or proximity of low flying aircraft.

In another related embodiment, the information may be collected and stored within the system's memory over time for analysis to create a usage schedule of the infant. The schedule may be displayed or utilized to alert the user of upcoming feeding events.

In an embodiment, the system may receive the collected information and determine if a user of the container is likely to heat or cool a container of liquid based, at least in part, on the information. To this end, the system includes a communication port that in configured to operatively communicate with the server or personal computing devices.

In accordance with another embodiment, the server may analyze the collected information to provide heating and cooling commands to the system. To this end, the system may receive commands over a network to heat or cool from the server. The commands may augment the system's analysis of the collected information. The server may be connected via a network or via the Internet. In another related embodiment, the system may receive commands from personal computing devices.

In accordance with the various embodiments, the system may determine if a user is likely to heat or cool a container based, at least in part, on the proximity of the container of liquid to the user. The system may then heat or cool the container when the user is less than a predefined distance away from the container.

The system may additionally determine the state of the infant, such as whether the infant is awake or asleep. In an embodiment, the system may employ the infant's wake information and the user's proximity information, among others, to determine whether to initiate various control states of the device. To this end, the system may determine proximity of an electronic device to the milk temperature control device. The electronic device may include a personal computing device selected from a group consisting of mobile phones, cellphones, smartphones, tablets, mobile computing devices, laptops, computers, desktops, servers, and radio transmitters. The system may also determine proximity based on a presence of the electronic device being within a distance to the milk temperature control device. Initiation of the control state may be based on the proximity of the electronic device being within a specified distance and/or a specified time. The specified distance and/or specified time may be an input received from the electronic device.

In a related embodiment, the system may operatively communicate with an infant monitor device. Such device may be configured to measure infant's movement and physiological information. The monitoring device may be configured to determine the state of the infant, such as wake state and/or asleep state and/or mood. The system may receive the state of the infant information from the monitor device.

In accordance with another embodiment, the system may determine a mood of the infant using information associated with the infant. Such information may be derived from sensor readings and/or measurement of the infant's movements, sound levels, and/or perspiration levels.

In accordance with another embodiment, the system may determine a likelihood value associated with the feeding of the subject, such as an infant, based on the received state information. The system may cause the initiation of the control state based on the likelihood value exceeding a specified threshold. The state information may be selected from a group consisting of a subject's awake state, a subject sleep state, a subject's quiet asleep state, a subject's active sleep state, a subject's drowsy awake state, a subject's quiet alert awake state, subject's quiet state, a subject's deep sleep state, a subject's light sleep state, a subject's alert state, a subject's active state, a subject's active alert state, a crying cue, a fussing cue, a spitting cue, a gagging cue, a jittery cue, a jerky cue, a frowning cue, a red cue, a pale cue, an agitated cue, a thrashing cue, a falling sleep cue, an averting gaze cue, a smiling cue, a smooth motor movement cue, and a subject orientation. The state information may be collected from sensors selected from a group consisting of a microphone, a temperature sensor, an accelerometer, a capacitance sensor, an inductance sensor, a gyroscopic sensor, a scale, a conductance sensor, and an infrared sensor. The state information may be determined from measured movements of the subject or collected from a countertop monitoring apparatus.

In accordance with another embodiment, the system may calculate an estimated time of arrival of the electronic device to the milk temperature control device based on the proximity. The system may then initiate the control states based on the estimated time of arrival being within a specified time. The specified time may be an input received from the electronic device.

In accordance with another embodiment, the system may notify a user of a status of a milk temperature control device. The system may receive spatial information of a personal computing device. The system then determines a proximity value associated with proximity of the personal computing device from the milk warmer based on the spatial information. The system then calculates an estimated time of arrival of the personal computing device to the milk warmer based on the proximity value. During or subsequent to retrieval of the proximity information, the system also receives state information associated with a subject. The system then causes the initiation of a control state of the milk temperature control device based upon the received state information and the proximity information of the personal computing device. To this end, the initiation may be based on a specified distance, which may be an input received from the personal computing device.

In accordance with another embodiment, the system may alert the user of an expected infant's feeding time. The system may store information associated with feeding of an infant and determine a feeding schedule for the infant based on a statistical analysis of the stored information. The system then causes an output to the user of the next feeding time. The stored information may include at least a time and date value associated with the feeding, a time value associated with the heating, and weight information of the milk. The determined feeding schedule may include a next feeding time value.

In a related embodiment, the system may determine a current time. The system may initiate the heating state of the milk warmer if the current time is after the next feeding time by a specified value.

In accordance with another embodiment, the system may determine a mood state of the infant based on collected information associated with the infant. To this end, the system may cause the initiation of a control state of the milk temperature control device based on the mood state.

In accordance with another embodiment of the invention, a system for heating or cooling a container of liquid includes means for collecting information associated with use of the container. The system further includes means for determining if a user of the container is likely to heat or cool a container of liquid based, at least in part, on the information. The system further includes means for heating or cooling the container of liquid as a function of the determination.

In accordance with another embodiment of the invention, a system for controlling a milk temperature control device includes means for receiving a command, over a network, to heat a milk warmer. The system further includes means for initiating a control state of the milk temperature control device based on the received command.

In accordance with another embodiment of the invention, a system for controlling an infant's milk temperature control device includes means for receiving state information associated with a subject. The system further includes means for causing the initiation of a control state of the milk temperature control device based on the state information.

In accordance with another embodiment of the invention, a system for alerting a user of an expected infant's feeding time includes means for storing information associated with feeding of an infant, including at least a time and date value associated with the feeding, a time value associated with the heating, and weight information of the milk. The system further includes means for determining a feeding schedule for the infant based on a statistical analysis of the stored information, the determined feeding schedule including a next feeding time. The system further includes means for causing an output to the user of the next feeding time.

### BRIEF DESCRIPTION OF THE DRAWINGS

The foregoing features of embodiments will be more readily understood by reference to the following detailed description, taken with reference to the accompanying drawings, in which:

FIG. 1 schematically illustrates an infant-milk warmer and cooler system according to an illustrative embodiment of the invention;

FIG. 2 illustrates a detail schematic of the infant-milk warmer and cooler system of FIG. 1 according to an embodiment of the invention;

FIG. 3 schematically illustrates the infant-milk warmer and cooler system coupled to a controller for monitoring movements of infants according to an embodiment of the invention;

FIG. 4 schematically illustrates a method of operating the infant-milk warmer and cooler system according to an embodiment of the invention;

FIG. 5 schematically illustrates a method of determining a likelihood value for operating the infant-milk warmer and cooler system based on the infant's state and the user's proximity according to an embodiment of the invention;

FIG. 6 schematically illustrates a method of determining a likelihood value for operating the infant-milk warmer and cooler system based on a user's location according to an embodiment of the invention;

FIG. 7 schematically illustrates another method of determining a likelihood value for operating the infant-milk warmer and cooler system based on a user's location according to an embodiment of the invention;

FIG. 8 schematically illustrates another method of operating the infant-milk warmer and cooler system according to an embodiment of the invention;

FIG. 9 schematically illustrates a method of initiating heating of the infant-milk warmer and cooler system based on a user's location according to an embodiment of the invention;

FIG. 10 schematically illustrates a method of initiating heating of the warmer based on a monitored state of the infant according to an embodiment of the invention;

FIGS. 11(a-e) show exemplary screen shots that may be displayed on a personal computing device, in accordance with various embodiments of the invention; and

FIG. 12 shows an embodiment of the infant-milk warmer and cooler system of FIG. 1 according to an embodiment of the invention.

### DETAILED DESCRIPTION OF SPECIFIC EMBODIMENTS

As used in this description and the accompanying claims, the following terms shall have the meanings indicated, unless the context otherwise requires:

The term “infant” refers to a subject that receives milk and other nutrients having lactose. The subject includes, without limitations, neonates, toddlers and very young children.

The term “container” refers to a vessel for containing and serving milk (for example, diary milk, breast milk, milk formula, infant formula, and other type of liquid nutrients that generally contains lactose) and may include vessels, such as bottles, feeding bottles, and infant bottles.

In illustrative embodiments of the invention, a reliable milk temperature control system and methodology is disclosed. The system and method employs collected information associated with, for example, the infant and/or the caregiver, to control the storage and preparation of a container of milk. Details are described below.

In various embodiments of the invention, the system controls when to initiate heating or cooling of the container by determining if a user (for example, caregiver) is likely to heat or cool a container of milk. Furthermore, the determination and/or initiation may occur without user intervention. As a consequence, the system may beneficially allow the caregiver to feed the infant without having to wait, and provide the caregiver more opportunity to rest between the feeding of the infant. Conventional warming devices in the art do not predict when, or if, an infant needs a bottle of formula or milk, nor do they preemptively warm a bottle before a user (for example, caregiver) needs it based on that prediction. To that end, when feeding an infant, the user typically has to wait to heat the milk to a desired feeding temperature.

In further embodiments of the invention, the system may monitor the observed feeding behavior of the infant. The system may beneficially generate notifications to the caregiver to alert him or her of future feeding events as well as provide a report for tracking the growth and health of the infant.

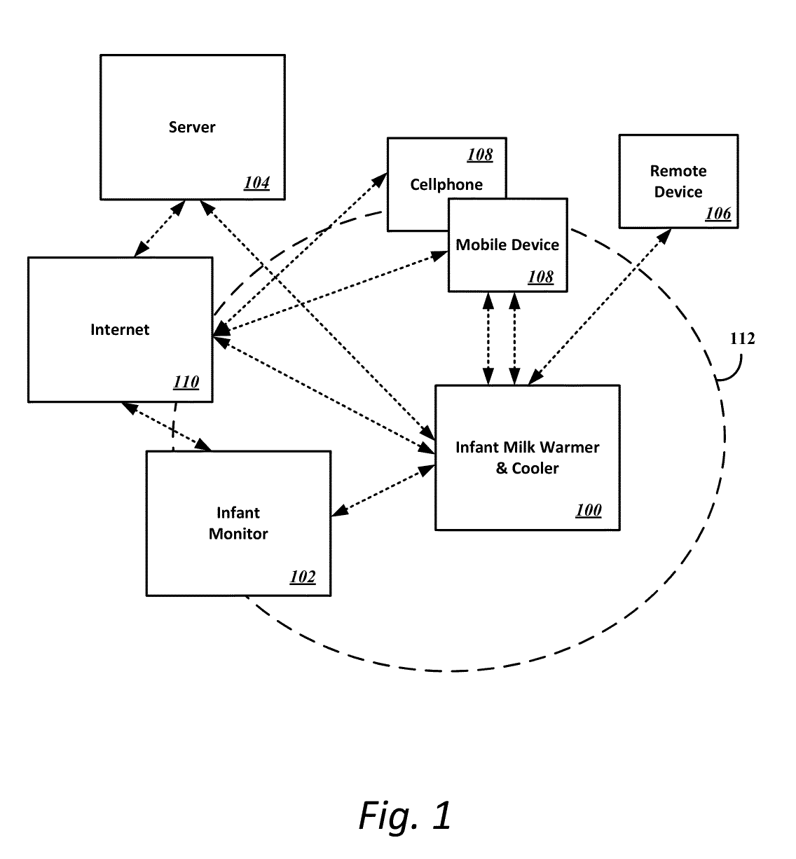

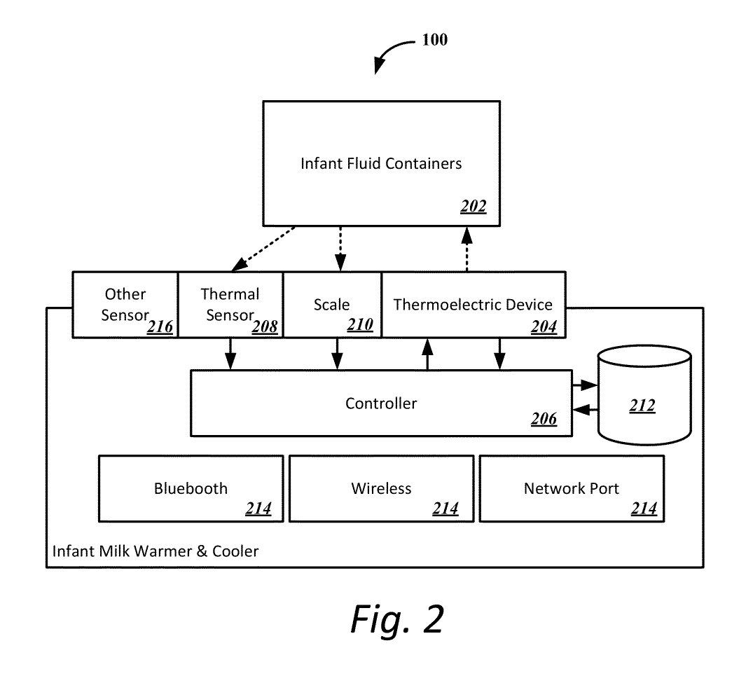

FIG. 1 schematically illustrates a milk temperature control system 100 according to an illustrative embodiment of the invention. The system 100 (referred to in the figure as “infant-milk warmer and cooler system 100”) is configured to both cool and heat a container 202 (see FIG. 2). Preferably, the system 100 is a countertop or portable device configured to both maintain the temperature of the milk at a desired storage temperature by cooling the container 202 preferably, without limitation, between about 32° F. and 40° F. The system 100 is also configured to increase the temperature of the milk to either a desired feeding temperature preferably between room temperature and typical body temperature or a desired pre-heat temperature, which is an intermediate temperature between the desired storage temperature and the desired feeding temperature.

The apparatus 100 may include at least one communication port to operatively communicate with at least one external device, such as an infant monitor 102, a server 104, a remote device 106, or a communication device 108 (for example, a mobile phone or a mobile computing device). The apparatus 100 may communicate directly with such devices or indirectly over a network 110 (for example, Internet, wide area network, and/or local area network).

In various embodiments, the infant monitor 102 may collect information associated with use of the container 202. Illustratively, the information may be associated with an infant. For example, the information may include various states of the infant, physiological responses of the infant, movements of the infant, environmental condition around the infant, and orientation of the infant. State information may include, for example, mental or body or behavioral state information relating to:
The infant's awake state (for example, alert awake state, drowsy awake state, quiet alert awake state);
The infant's sleep state (for example, quiet sleep state, active sleep state, deep sleep state, light sleep state); and
The infant's cues (for example, crying cue, fussing cue, spitting cue, gagging cue, jittery cue, jerky cue, frowning cue, red cue, pale cue, agitated cue, thrashing cue, falling sleep cue, averting gaze cue, smiling cue, smooth motor movement cue).

Environmental condition around the infant may include sound, room temperature, humidity levels, light levels, and the presence of people in the room. Physiological responses may include information associated with body functions, such as heart rate, breathing rate, perspiration, body temperature, voluntary muscle movement and involuntary muscle movement.

The collected information allows the system 100 to determine whether the infant is awake or about to wake. It should be appreciated by one skilled in the art that determining the infant awake state may also be determined based on the infant's sleep state. The system 100 may use either awake or asleep information to determine by prediction or estimation at least one of: a likelihood that the infant is hungry or a likelihood that the infant wants to be fed or a likelihood that a temperature control event (for example, heating of the container 202) is imminent. The determined likelihood information may be further combined with information associated with the caregiver to improve the reliability of the prediction, particularly in determining the likelihood that a heating of the container 202 is imminent. It should be appreciated by one skilled in the art that determining when to heat may also be ascertained by determining when to cool (for example, when not to heat).

FIG. 2 illustrates a detail schematic of the infant-milk warmer and cooler system 100 of FIG. 1 according to an embodiment of the invention. The system 100 may accept a container 202 in an integrated heating and cooling unit 204 (referred to also as a “thermoelectric device 204”) for both heating and cooling the container 202 when energized. The system 100 may include a plurality of thermoelectric devices 204 for a plurality of containers 202. Each of the thermoelectric devices 204 may be configured for a container 202.

The system 100 includes a controller 206 that may record, without limitation, information associated with the environment as well as the container, or the liquid therein. Such information may be stored, without limitation, in a storage or memory device, such as a Random-access memory (RAM) device, or other memory device known in the art. The storage or memory device may be based on, without limitation, a semiconductor technology, a magnetic technology and/or an optical technology. The information may be, without limitation, derived by the controller 206, and/or received from: a user interface (for example, a keypad, touch panel, and/or switches); a sensor; and /or other devices associated with the system 100. The information may include:
Time of use (for example, time and date and/or frequency) of the system 100;
Container temperature (for example, the thermoelectric device temperature and/or the container's surface temperature);
Environment condition (for example, the room temperature, light levels, humidity levels, ambient sound levels, and the presence and proximity of certain neighborhood noises—such as the proximity of low flying aircraft and traffic and the presence of nearby animals);
Presence of caregiver (for example, the proximity and/or identity of people in the same room as the infant);
Container information (for example, weight and/or quantity of liquid);
Milk information (for example, type thereof, the expected spoilage date, and the preferred consumption date);
Infant information (for example, age, weight, time asleep, time awake, body temperature, movement, mood, and sound levels); and
Controls information (for example, total cooling time over a defined time, total heating time over the defined time, desired heating temperature, and desired storage temperature) of the system 100.

Using the recorded information, the system 100 may determine if a user (for example, a caregiver) is likely to want or need a container 202 of heated milk. If it is determined that a user is likely to use the system 100 within a specified time period, the system 100 may initiate heating or cooling of the container 202. The system 100 may include, without limitations, a thermal sensor 208, a scale 210, and various other sensors 216 for collecting the recorded information. The recorded information may be stored in memory 212 for analysis over time.

The system 100 may include communication ports 214 for interfacing to a network to receive signals and data to control its operation, including the initiation of various temperature and network controls. The communication port 214 may communicate, for example, via a Bluetooth transceiver (for example, IEEE 802.15.1), a Wi-Fi transceiver (for example, IEEE 802.11), a Zigbee transceiver (for example, IEEE 802.15), or a FM/AM radio transceiver to receive control signals from the wireless network or directly from the infant monitor 102, the server 104, the remote device 106, or the communication device 108. Communication device 108 may include a personal computing device, including, without limitation, a personal phone, a computer, a tablet, or any other suitable electronic device which is connected to the internet and can display an output. The system 100 may communicate its collected information (for example, sensor and usage information) to the server 104 via the network for storage and analysis over time.

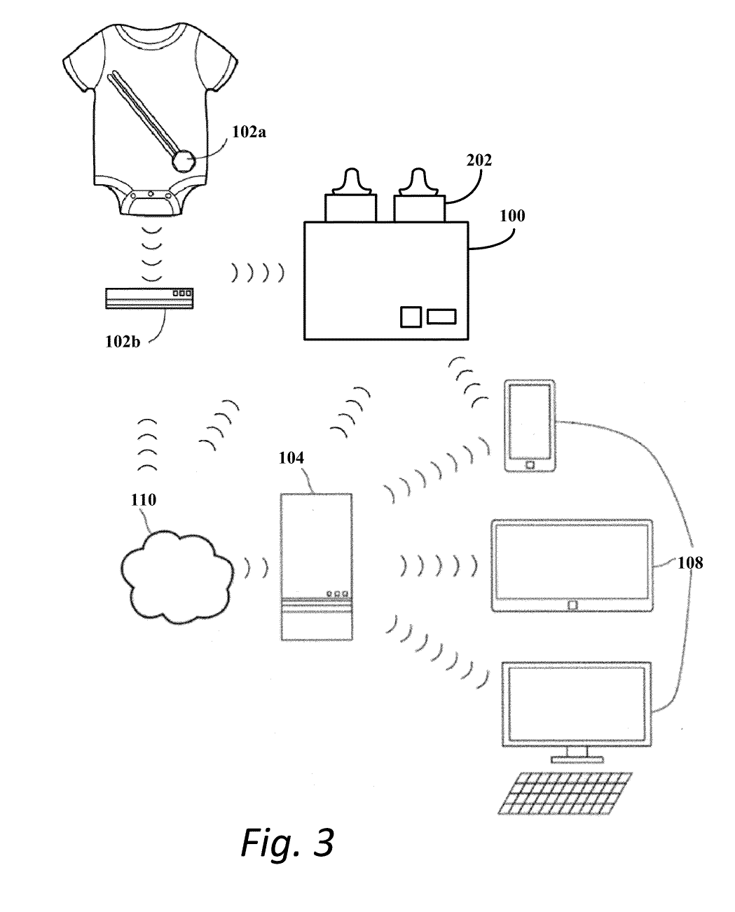

FIG. 3 schematically illustrates the infant-milk warmer and cooler system 100 coupled to an infant monitor 102, or other external and intermediate devices (104, 108, and 110) for monitoring movements of infants according to an embodiment. An example of the controller is described in U.S. publication no. US2013/0197387, by Thomas Lipoma et al., and is incorporated by reference herein in its entirety. The infant monitor 102 may include a controller 102a for monitoring information from sensors embedded in articles of clothing of the infant. The controller 102a may interface directly to the system 100 or through an intermediate base station 102b. The base station 102b may be alternatively configured to transmit the collected information either to the server 102, which then stores and analyze the information to provide commands to the system 100, or directly to the system 100.

Referring back to FIG. 1, the system 100 may employ proximity information 112 of the user (for example, the caregiver) to initiate the controls of the temperature of the container. For example, the system 100 may use geographic location of the user and wait until the user is within a specified distance from the system 100 before performing a control action. The proximity information may be based on spatial information (for example, GPS data or mobile location information) or wireless network information (for example, a presence of a wireless device or the signal strength of the device or the presence of a broadcast message).

Additionally, the system 100 may record, store, or track metrics of the infant. The metrics may include, but not limited to:
Wake time and/or frequency;
Sleep time and/or frequency;
Movements;
Skin temperature;
Crying time and/or frequency;
Mood;
Weight; and
Diet (consumption or type of milk).

The system 100 may additionally be configured to receive information from the user about the infant from, for example, a user interface. Such information may, for example, be related to the type of milk or brand being fed to the infant.

The system 100 may use any or all of the above information, including time of use, container temperature, environment condition, presence and proximity of the caregiver, container weight, milk information, infant information, and system controls information, to determine whether a user is likely to heat or cool a container.

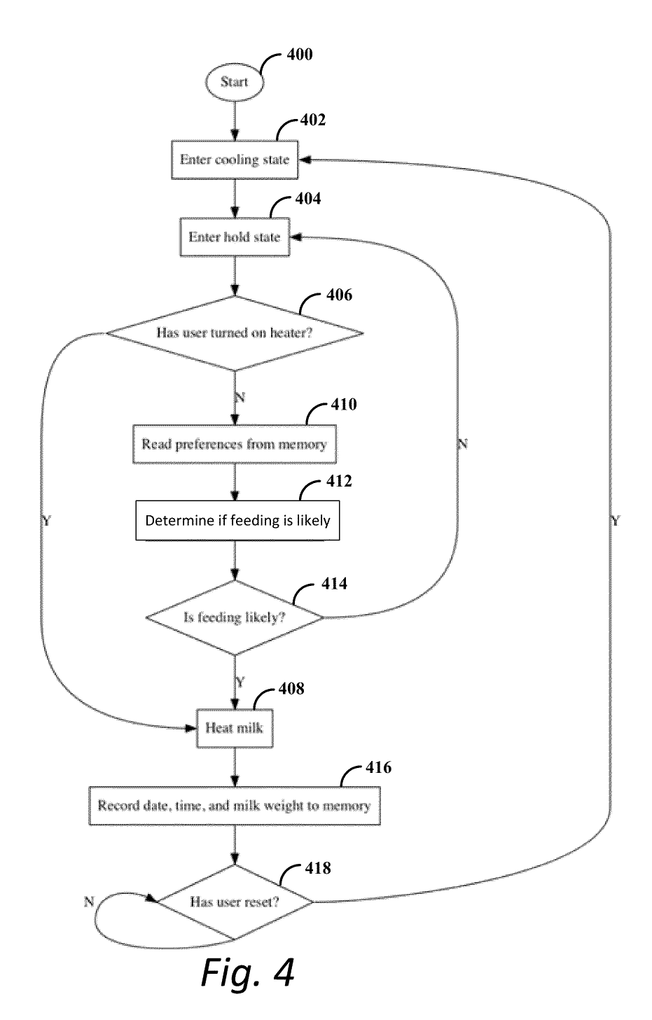

Referring now to the embodiments in more detail, FIG. 4 schematically illustrates a method of operating the infant-milk warmer and cooler system. More particularly, the figure shows a flow diagram depicting an exemplary process 400 of a heating or cooling apparatus.

The methodology may, without limitation, incorporate a state machine that allows heating or cooling based on stored user preferences. When the process 400 is first started, the system 100 optionally may enter a cooling state 402 to control the temperature of the thermoelectric device 204, or the container 202, to a specified storage temperature, preferably between about 32° F. and 40° F. The control may be based, for example, on a proportional-integral (PI) regulator or proportional-integral-derivative (PID) regulator.

The system 100 may then enter a hold state 404 to maintain regulation of the temperature of the thermoelectric device 204 or the container 202 at the specific storage temperature. The system 100 may then check (in state 406), in a memory address or buffer associated with an input of the user, to determine if a user has indicated a change of the heating or cooling state being desired. The memory address or buffer may be linked, for example, to: a switch on the system 100 or a command to be received via the communication port from an external device (for example, the server 104, the remote device 106, or the communication device 108). To that end, the user may manually initiate the control state to heat the milk either remotely via the network or directly via an input at the countertop or portable system 100. If a data value at the memory address or the buffer indicates a change in temperature being desired, the system 100 then enters a heating state 408 and stores (in state 416) information about the change to memory 212 before waiting (in state 418) for the user to reset. Of course, the system 100 may enter a cooling state in a similar manner to the entry of the heating state 408.

The data value may change by a setting that the user provides to the system 100. For example, the setting may include program time and control levels, such as the desired storage and heating temperatures. The setting may also be rules or conditions for the system 100. To that end, the user may provide user customizable rules to initiate the controls. The customization rules, for example, may be associated with the use of the container 202, observed environmental conditions associated with the infant, observed infant movements, and/or detected proximity of the user to the system 100.

If the data value indicates that the user does not want a change in temperature, the system 100 reads (in state 410) information associated with use of the container 202 from the memory 212 and then determines (in state 412) if the user is likely going to request a change in temperature control state in the near future. If the system 100 determines (in state 414) that a change of state is likely desired, the system 100 changes to a heating or cooling state 408. The system 100 then records (in state 416) information about the change to memory 212 and waits (in state 418) for the user to reset the system 100, such as for the next feeding.

In state 412, the controller 206 may evaluate inputs in the form of preferences from the user. Alternatively, the controller 206 may evaluate data to determine a likelihood value associated with the infant being hungry or wanting to be fed or a likelihood value indicating that a temperature control event is imminent. The evaluation may be a parallel process running concurrently with the process 400, or a process initiated by process 412.

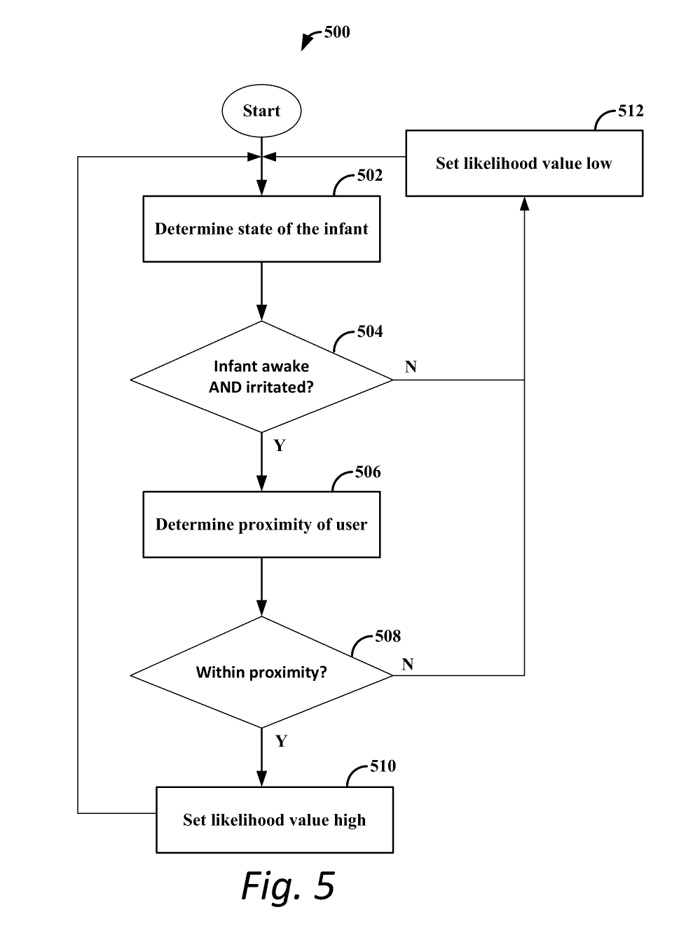

FIG. 5 schematically illustrates a method of determining a likelihood value for operating the infant-milk warmer and cooler system 100 based on the infant's state and the user's proximity according to an embodiment of the invention. The process 500 begins with the system 100 determining (in state 502) either a wake state or a sleep state of the infant. The wake/sleep state may, for example, be received from the infant monitor 102 or determined from collected information (for example, movement information associated with the infant) from the infant monitor 102. The system 100 then determines (in state 504) whether the infant is either awake or not asleep.

Additionally, in state 504, the system 100 may determine a mood state of the infant. The mood state may include, but is not limited to, whether the infant is agitated, which may be based on a detection of: rapid breathing by the infant, elevated level of perspiration, elevated level of movements (for example, of the upper and lower extremities), or crying. Upon the system 100 determining that the infant is awake and agitated, the system 100 may then determine the proximity of the user to the system 100 (state 506). The proximity may be determined based on spatial information (for example, GPS data or mobile location information) or wireless network information (for example, a presence of a wireless device or the signal strength of the wireless signal or the presence of a broadcast message). The system 100 may evaluate the spatial information to determine whether the user is within a specified distance from the system 100. The specified distance may be provided as an input from the user. Upon both conditions being satisfied, the system 100 may set (in state 510) the likelihood value, that a temperature control is imminent, as high. If both conditions are not satisfied, the system 100 may set (in state 512) the likelihood value as low.

To determine the mood state, the system 100 may combine data values associated with the state of the infant, the physiological responses of the infant, the movements of the infant, the environmental condition around the infant, and the orientation of the infant. In an embodiment, the combination may, for example, be based on a weighted sum of various sensor readings, such as those from a microphone, an accelerometer, a conductance sensor, an inductive sensor, a conductivity sensor, a light sensor, and a thermal sensor. In another embodiment, the combination may be based on statistical analysis of the various sensor readings associated with the infant and the user's location/proximity to the system 100 to determine the infant's mood. Such statistical analysis may include regression analysis, clustering analysis, and/or modeling analysis.

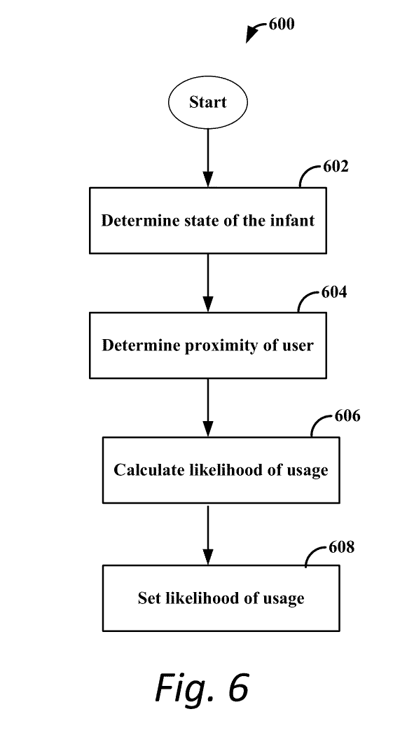

FIG. 6 schematically illustrates another method of determining a likelihood value in which the value indicates that a temperature control is imminent according to an embodiment of the invention. The process 600 begins with the system 100 determining (in state 602) a wake or asleep state of the infant. The system 100 then may determine (in state 604) the proximity of the user to the system 100. The system 100 then employs the proximity and the state of the infant to calculate (in state 606) a likelihood value as a transfer function. The system 100 then may store (in state 608) the likelihood value in memory 212. The resulting likelihood value may be compared to a specified threshold; the result of the comparison being an indicator that a temperature control event is imminent.

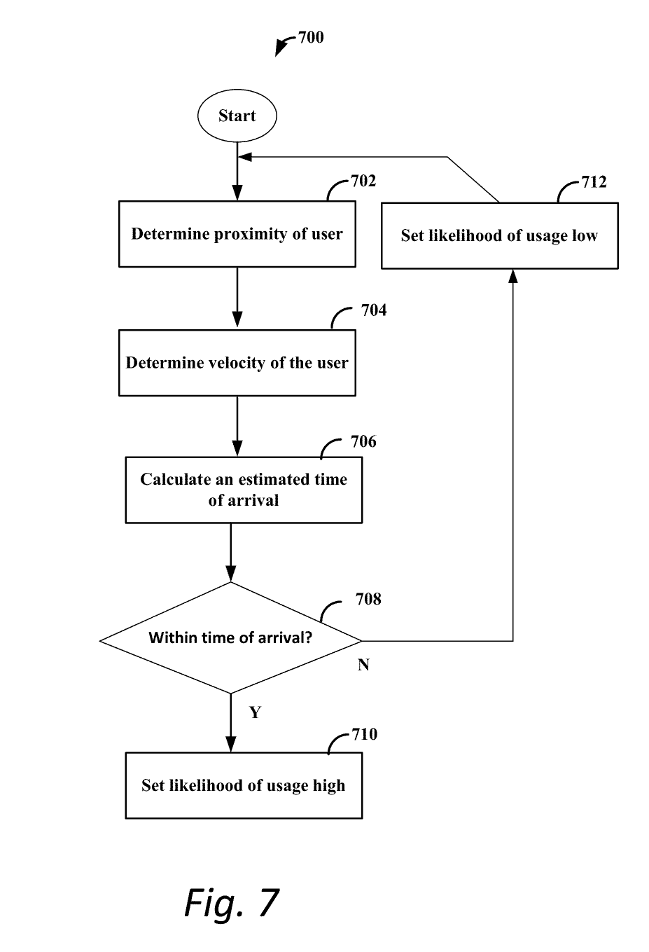

FIG. 7 schematically illustrates another method of determining a likelihood value in which the value indicates that a temperature control is imminent according to an embodiment of the invention. The process 700 begins with the system 100 determining (in state 702) proximity of the user to the system 100. The proximity may be determined based on spatial information (for example, GPS data or mobile location information) or wireless network information (for example, a presence of wireless device or the signal strength of the wireless device or the detection of a broadcast message). The system 100 then calculates or receives (in state 704) a value associated with the velocity of the user; the value determined based on the spatial information. Using the velocity information, the system 100 calculates (in state 706) an estimated time of arrival between the user and the system 100. If the estimated time of arrival is within a specified threshold (in state 708), the system 100 set (in state 710) the likelihood value of imminent usage to high, else the system 100 set (in state 712) the likelihood value to low.

In another embodiment, the system 100 may initiate temperature controls based on the estimated time of arrival of the user to the system 100. The system 100 may, for example, determine a rate of change of the user location based on the received spatial information recorded over time. The system 100 may then calculate an estimated time of arrival for the user to the system 100 based on the user's current proximity to the system 100 and the determined rate of change. The estimated time of arrival may be an input provided by the user. The system 100 may initiate the controls, for example, once the estimated time of arrival is less than the time to control the temperature of the milk to the desired heating temperature.

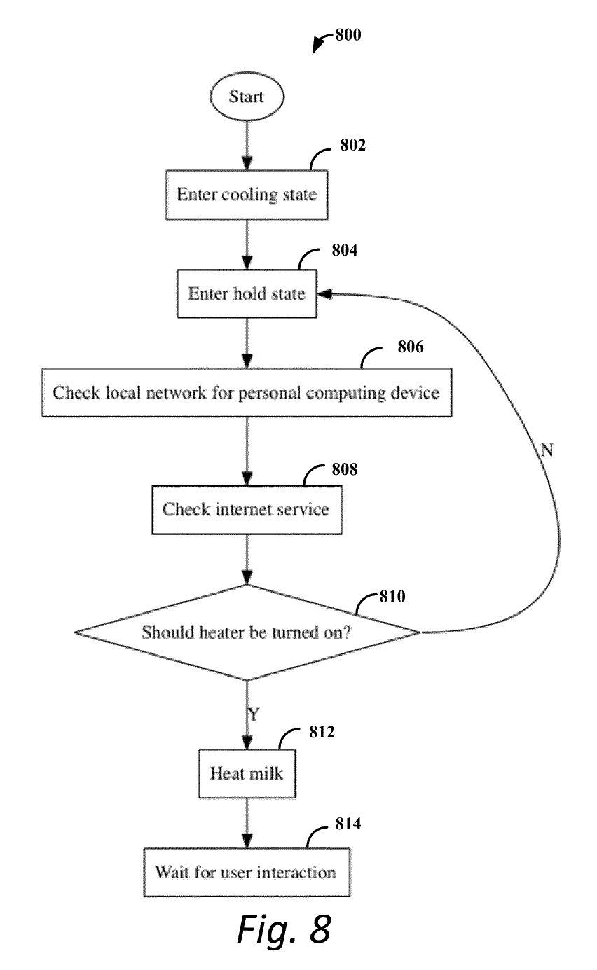

FIG. 8 schematically illustrates a method 800 of operation of the infant-milk warmer and cooler system 100 according to an embodiment of the invention. The method 800 determines if a heating or cooling device should be activated based on information received from a network or internet service. When the process is first started, the system 100 may optionally enter a cooling state 802 and then enters a hold state 804 regulating the temperature at the desired storage temperature. The system 100 then checks (in state 806) for a local wired or wireless network or wireless receiver for data associated with the initiation of the temperature controls. The data may be received from the infant monitor 102, the remote device 106, or the communication device 108. The process then checks (in state 808) for an internet service over a network for data associated with the initiation from the server 104. If a command signal is received (in state 810), the system 100 initiates the temperature controls of the warmer (in state 812) before waiting for further user interaction (in state 814).

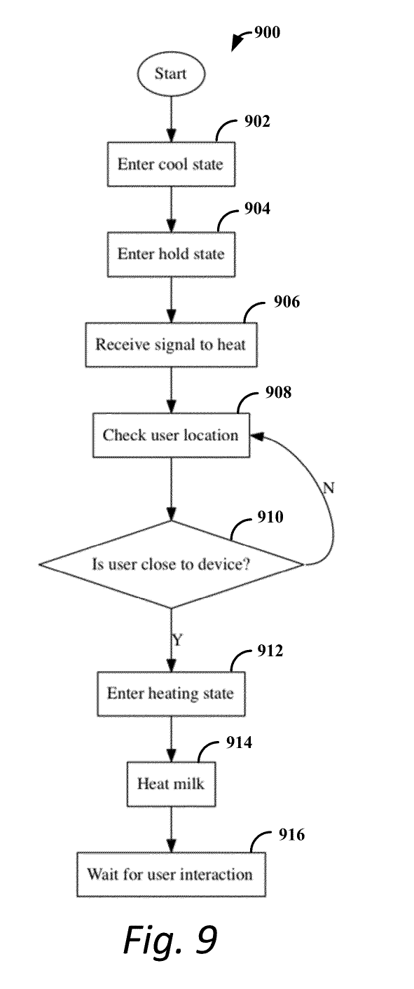

FIG. 9 schematically illustrates a method of initiating temperature controls of the infant-milk warmer and cooler system 100 based on a user's location according to an embodiment of the invention. When the process 900 is first started, the system 100 may optionally enter a cooling state 902 then enters a hold state 904 at a specified storage temperature. The system 100 then waits (in state 906) for a command from the user or a device associated with the user to change heating or cooling state. Once a signal is received, the system 100 then checks (in state 908) for the user's location.

If the user is not within a defined distance to the system 100, the system 100 waits and continues to check (in state 910) for the user location. If the user is within a defined distance to the system 100, the system 100 enters (in state 912) a temperature control state to heat the container 202. The system 100 heats (in state 914) the container 202 and then waits (in state 916) for further user interaction.

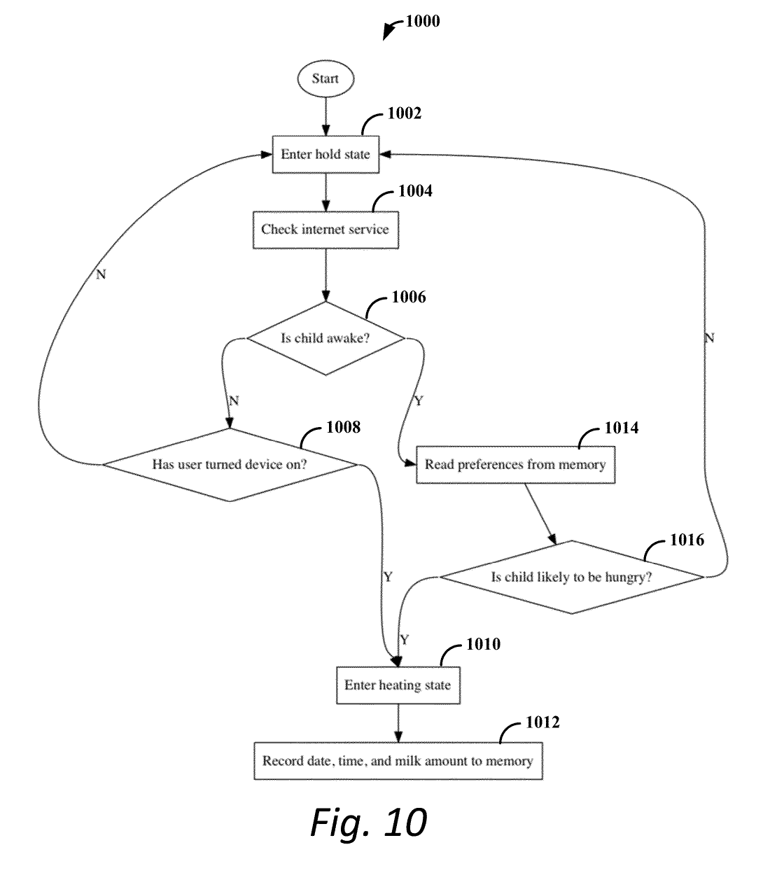

FIG. 10 schematically illustrates a method of initiating heating of the warmer based on a monitored state of the infant, in accordance with an embodiment of the invention. The figure shows a flow diagram depicting an exemplary process 1000 of a heating or cooling device in accordance with an embodiment of the invention. As shown, the methodology may, without limitation, incorporate a state machine that allows heating or cooling depending on input from a monitoring device (for example, the infant monitor 102). When the process 1000 is first started, the system 100 enters a hold state 1002. The system 100 then checks an internet service over a network to determine (in state 1004) if an infant is awake. If the internet service indicates that the infant is not awake (in state 1006), the system 100 then determines (in state 1008) if a user has requested a change of the control state. If the user has not requested a change of the control state (in state 1008), the process goes back to the hold state 1002. If the user has requested a change of the control state, the system 100 enters a heating or cooling state 1010 before recording information about the event to memory.

If the internet service indicates that the infant is awake (in state 1006), the system 100 reads (in state 1014) data and preferences from the memory 212 to determine (in state 1016) if the infant is likely to be hungry. If the system 100 determines (in state 1016) that the infant is not likely to be hungry, the system 100 enters the hold state 1002. If the system 100 determines the infant is likely to be hungry (in state 1016), the system 100 enters the heating or cooling state 1010 before recording (in state 1012) information about the event to memory.

In various embodiments of the invention, the system 100 may create a usage schedule (for example, a feeding schedule) by employing statistical analysis of the various sensor readings associated with the infant or the container, time of use recording, and user's location/proximity to the system 100. Such statistical analysis may include regression analysis, clustering analysis, and/or modeling analysis. The feeding schedule may be an average of the amount of milk consumed over a day and week as well as the histogram of the feeding time. The schedule may be analyzed by days of the week to account for potential variations in the caregiver's schedule.

In another aspect of the embodiment, the system 100 may provide a notification of the next expected feeding time. The system 100 may, for example, determine an average amount of milk consumed in a defined time period. This time period may, for example, be over a day. Using regression analysis, the system 100 may determine a quantity of milk to be consumed over the course of the day. By further using the collected information of when the infant was last fed and the amount consumed, the system 100 may extrapolate the next occurrence of the feeding as well as the expected amount of consumption. The system 100 may beneficially display this information on the countertop device or transmit the information to the server 104 or the communication device 108.

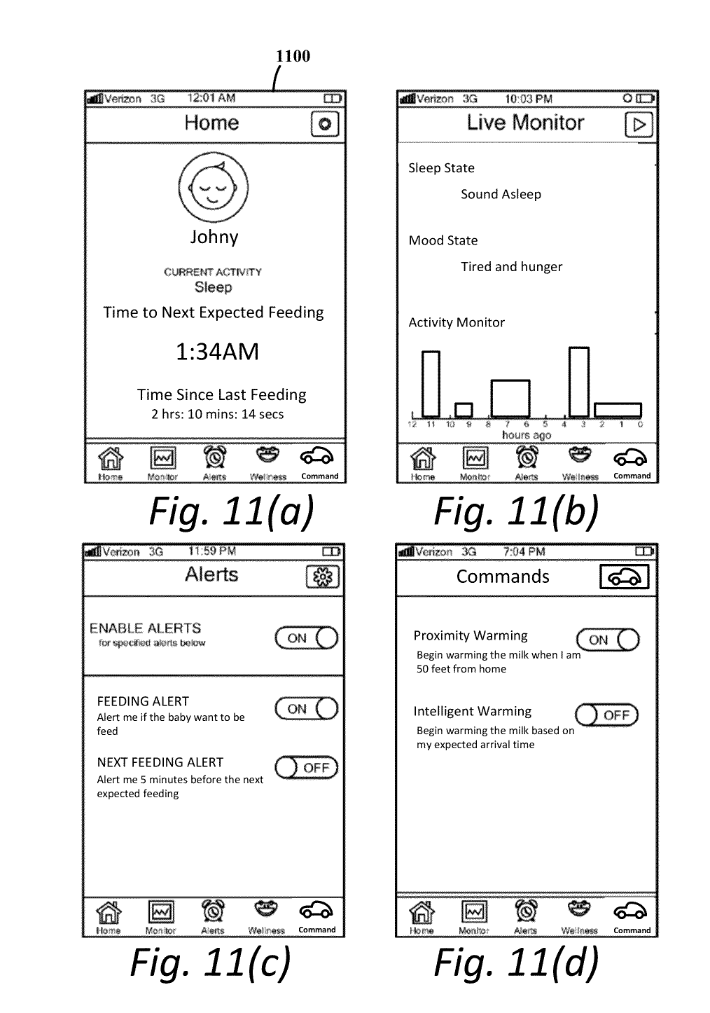

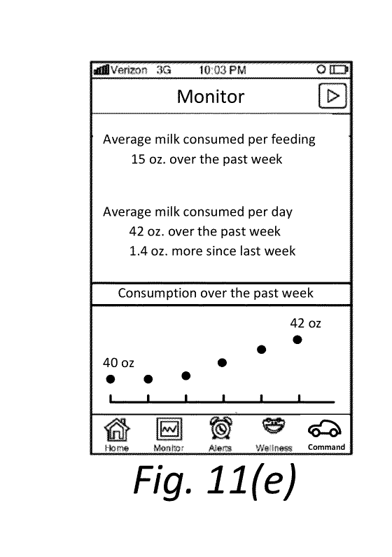

The system 100 may send alerts, notification and/or reports to the user based on such information. FIGS. 11(a-e) show exemplary screen shots that may, for example, be displayed on a personal computing device in accordance with various embodiments of the invention.

More particularly, FIG. 11(a) shows a home display mode, in which relatively general information pertaining to an infant is displayed. Such information may include, for example, the current activity (for example, awake or sleep), the time to next expected feeding, and the time since last feeding. Other home display mode may be configured to alternatively display the infant's body position (for example, laying on chest or back) and skin temperature. Other display modes, such as, without limitation, monitor, alert setting, wellness, and commands, may be viewed by selecting the appropriate button at the bottom of the screen.

FIG. 11(b) shows a live monitor mode associated with the infant feeding, in which contemporaneous data from the sensors may be displayed and/or various alerts. For example, and without limitation, current sleep, wake state, and mood state may be viewed. Consumption data over the past several months, including consumption amount, may be viewed.

FIG. 11(c) shows an alert setting mode, which allows the user the capability to select and enable various alerts. These alerts may include, without limitation, a feeding alert and a next feeding alert.

FIG. 11(d) shows a command set up mode, which allows the user to enable temperature-control functions associated with the system 100. For example, and without limitation, the mode may include a function to initiate temperature controls based on proximity of the user to the system 100. The user may also specify specific temperatures of the desired storage temperature, the desired feeding temperature, or the desired pre-heat temperature.

FIG. 11(e) shows a monitor mode, which allows the user to view report associated with the infant's consumption of milk. The consumption data over the past several days, weeks, or months, including consumption amount, may be viewed.

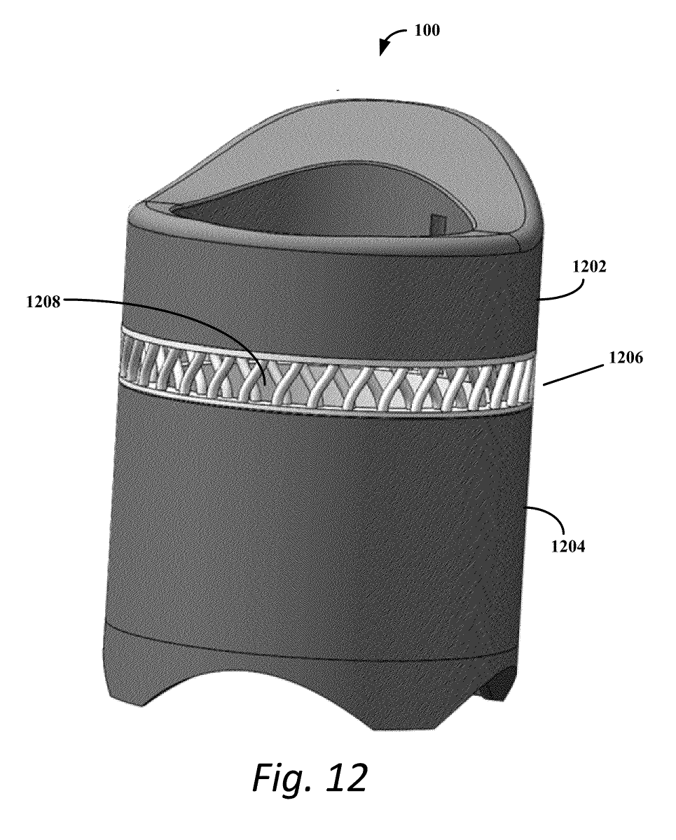

FIG. 12 shows an embodiment of the infant-milk warmer and cooler system 100 of FIG. 1 according to an embodiment of the invention. The system 100 has a top portion 1202 and a lower portion 1204 connected across a gap region 1206. The gap region 1206 connects between the top and lower portions 1202, 1204 while thermally insulating the two portions 1202, 1204. The top portion 1202 preferably houses the controller 206, the memory 212, and the communication port 214 (see items in FIG. 2). The lower portion 1204 preferably houses the thermoelectric device 204 and the scale 210 (see items in FIG. 2). A thermal conductive surface 1208 lines the inside surface 1208 of the lower portion and is operatively connected to the thermoelectric device 204. The thermal sensor 208 is preferably disposed in the lower portion 1204. Additional thermal sensors 208 may be employed and disposed in the top portion 1202.

Embodiments of the invention may be implemented in whole or in part in any conventional computer programming language. For example, preferred embodiments may be implemented in a procedural programming language (e.g., “C”) or an object oriented programming language (e.g., “C++”, Python). Alternative embodiments of the invention may be implemented as pre-programmed hardware elements, other related components, or as a combination of hardware and software components.

Embodiments can be implemented in whole or in part (for example, the controller) as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

The embodiments of the invention described above are intended to be merely exemplary; numerous variations and modifications will be apparent to those skilled in the art. All such variations and modifications are intended to be within the scope of the present invention as defined in any appended claims.

What I claim is:

1. A method of heating or cooling a container of liquid, the method comprising:
collecting information associated with use of the container;
determining if a user of the container is likely to heat or cool a container of liquid based, at least in part, on the information; and
heating or cooling the container of liquid as a function of the determination.

2. The method according to claim 1, wherein the container of liquid is a container of milk or infant formula.

3. The method according to claim 1, wherein the information includes usage statistics of the container.

4. The method according to claim 1, wherein the information includes information about the container of liquid.

5. The method according to claim 4, wherein the information about the container of liquid includes liquid volume, expiration date, weight, and/or temperature.

6. The method according to claim 1, wherein the information includes information about an infant.

7. The method according to claim 6, wherein the information includes infant age, weight, time asleep, time awake, temperature, movement, mood, and/or sound levels.

8. The method according to claim 1, wherein the information includes information about the environment including room temperature, location, light levels, sound levels, time, humidity levels, and/or proximity of low flying aircraft.

9. The method according to claim 1, wherein collecting information includes collecting and storing data to memory over time.

10. The method according to claim 1, wherein determining if a user is likely to heat or cool a container includes analyzing stored information over time to create a usage schedule.

11. The method according to claim 1, wherein determining if a user is likely to heat or cool a container includes accepting commands over a network to heat or cool.

12. The method according to claim 1, wherein determining if a user is likely to heat or cool a container is based, at least in part, on the proximity of the container of liquid to the user, and heating or cooling the container when the user is less than a predefined distance away from the container.

13. The method according to claim 1, wherein determining if a user is likely to heat or cool a container includes determining if an infant is awake.

14. The method according to claim 1, wherein heating is performed without user interaction.

15. The method according to claim 1, wherein cooling is performed without user interaction.

16. The method according to claim 1, wherein determining if a user is likely to heat or cool a container of liquid is performed without user interaction.

17. The method according to claim 1 further comprising:
prior to heating or cooling the container of liquid as a function of the determination, maintaining the milk temperature at a specified storage temperature.

18. A method of controlling a milk temperature control device comprising:
receiving a command, over a network, to heat a milk warmer; and
initiating a control state of the milk temperature control device based on the received command.

19. The method of claim 18 further comprising:
prior to initiating the control state, maintaining the milk temperature at a specified storage temperature.

20. A method of controlling an infant's milk temperature control device comprising:
receiving state information associated with a subject; and
causing the initiation of a control state of the milk temperature control device based on the state information.

21. The method of claim 20 further comprising:
determining a likelihood value associated with the feeding of the subject based on the received state information and causing the initiation of the control state further based on the likelihood value exceeding a specified threshold.

22. The method of claim 20, wherein the state information is selected from a group consisting of:
a subject's awake state, a subject sleep state, a subject's quiet asleep state, a subject's active sleep state, a subject's drowsy awake state, a subject's quiet alert awake state, subject's quiet state, a subject's deep sleep state, a subject's light sleep state, a subject's alert state, a subject's active state, a subject's active alert state, a crying cue, a fussing cue, a spitting cue, a gagging cue, a jittery cue, a jerky cue, a frowning cue, a red cue, a pale cue, an agitated cue, a thrashing cue, a falling sleep cue, an averting gaze cue, a smiling cue, a smooth motor movement cue, and a subject orientation.

23. The method of claim 22, wherein the state information is collected from sensors selected from a group consisting of:
a microphone, a temperature sensor, an accelerometer, a capacitance sensor, an inductance sensor, a gyroscopic sensor, a scale, a conductance sensor, and an infrared sensor.

24. The method of claim 20 further comprising:
prior to initiating the control state, maintaining the milk temperature at a specified storage temperature.

25. A method of alerting a user of an expected infant's feeding time comprising:
storing information associated with feeding of an infant, including at least a time and date value associated with the feeding, a time value associated with the heating, and weight information of the milk;
determining a feeding schedule for the infant based on a statistical analysis of the stored information, the determined feeding schedule including a next feeding time; and
causing an output to the user of the next feeding time.

26. The method of claim 25 further comprising:
determining a current time; and
initiating a heating state of the milk warmer if the current time is after the next feeding time by a specified value.

27. The method of claim 26 further comprising:
prior to initiating the heating state, maintaining the milk temperature at a specified storage temperature.
